(19) United States
(12) Patent Application Publication
(10) Pub. No.: US 2026/0023095 A1
(43) Pub. Date: Jan. 22, 2026

(54) APPARATUS AND METHOD FOR IDENTIFYING TARGET POSITION IN ATOMIC FORCE MICROSCOPE

(71) Applicant: PARK SYSTEMS CORP., Suwon-si (KR)

(72) Inventors: JeongHun AN, Suwon-si (KR); YongSung CHO, Suwon-si (KR); Sang-il PARK, Suwon-si (KR)

(73) Assignee: PARK SYSTEMS CORP., Suwon-si (KR)

(21) Appl. No.: 19/340,864

(22) Filed: Sep. 26, 2025

Related U.S. Application Data
(63) Continuation of application No. 17/561,731, filed on Dec. 24, 2021.

(51) Int. Cl. G01Q 60/38; G01Q 20/02; G01Q 70/08

(52) U.S. Cl. CPC G01Q 60/38; G01Q 20/02; G01Q 70/08

(57) ABSTRACT

Provided are an apparatus and a method for identifying a target position in an atomic microscope. An apparatus is configured to acquire result data identifying the cantilever from an image using an identification model learned to identify the cantilever based on the image photographed by a photographing unit, and calculate a target position from the cantilever using the acquired result data, in which the result data include at least one of bounding box data representing a bounding box including a boundary of the cantilever and segmentation data obtained by segmenting the cantilever and an object other than the cantilever.

### CROSS-REFERENCE TO RELATED APPLICATIONS

This application is a continuation of U.S. application Ser. No. 17/561,731, filed on Dec. 24, 2021.

### BACKGROUND OF THE DISCLOSURE

### Technical Field

The present disclosure relates to an apparatus and a method for identifying a target position in an atomic force microscope.

### Background Art

In general, a scanning probe microscope (SPM) means an apparatus for measuring physical parameters interacting between a sample and a probe when a nano-sized probe of a small rod called a cantilever approaches the surface of the sample. Such an SPM may include a scanning tunneling microscope (STM) and an atomic force microscope (AFM) (hereinafter, referred to as an ‘atomic microscope’).

Here, in the atomic microscope, laser light of an optical unit provided in the atomic microscope is irradiated to a position corresponding to the probe of the cantilever and as a result, the cantilever is bent so that the probe scans the surface of the sample, thereby acquiring a sample image imaging the shape (or curve) of the sample surface.

In order to acquire the sample image as described above, the cantilever needs to accurately identify a target position suitable for scanning the sample, but there is a problem that since the size and the shape thereof are varied according to a manufacturer of the cantilever, it is difficult to accurately identify the target position.

Therefore, an apparatus and a method for accurately identifying a target position in an atomic microscope are required.

### SUMMARY OF THE DISCLOSURE

An object to be achieved by the present disclosure is to provide an apparatus and a method for calculating a target position in an atomic microscope.

Specifically, an object to be achieved by the present disclosure is to provide an apparatus and a method for accurately identifying a target position regardless of the size and shape of a cantilever.

The objects of the present disclosure are not limited to the aforementioned objects, and other objects, which are not mentioned above, will be apparent to those skilled in the art from the following description.

According to an aspect of the present disclosure, there are provided an apparatus and a method for identifying a target position in an atomic microscope.

According to an aspect of the present disclosure, an apparatus for identifying a target position of an atomic microscope includes a cantilever configured so that a probe is disposed; a photographing unit configured to photograph an upper surface of the cantilever; and a control unit operably connected with the cantilever, the driving unit and the photographing unit, in which the control unit is configured to acquire result data identifying the cantilever from an image using an identification model learned to identify the cantilever based on the image photographed by the photographing unit, and calculate a target position from the cantilever using the acquired result data, in which the result data include at least one of bounding box data representing a bounding box including a boundary of the cantilever and segmentation data obtained by segmenting the cantilever and an object other than the cantilever.

According to another aspect of the present disclosure, a method for identifying a target position performed by a control unit of an atomic microscope includes the steps of photographing, by a photographing unit, an upper surface of a cantilever configured so that a probe is disposed; acquiring, by the photographing unit, result data identifying the cantilever from an image using an identification model learned to identify the cantilever based on the image photographed by the photographing unit; and calculating a target position from the cantilever using the acquired result data, in which the result data include at least one of bounding box data representing a bounding box including a boundary of the cantilever and segmentation data obtained by segmenting the cantilever and an object other than the cantilever.

Details of other exemplary embodiments will be included in the detailed description of the invention and the accompanying drawings.

According to the present disclosure, it is possible to accurately identify a target position regardless of the size and shape of the cantilever by using an artificial neural network model learned to identify the cantilever of an atomic microscope.

Further, it is possible to improve the identification performance of the atomic microscope by using the artificial neural network model described above to increase the operation rate and the operation speed for identifying the target position corresponding to the position of the probe.

Further, it is possible to automatically adjust the position of the cantilever by identifying the target position corresponding to the probe position of the atomic microscope so that the laser light of the optical unit is irradiated to a target position suitable to scan the sample by the cantilever.

The effects according to the present disclosure are not limited by the contents exemplified above, and other various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings.

FIGS. 1A and 1B are schematic diagrams for describing an atomic microscope system according to an exemplary embodiment of the present disclosure.

FIG. 2 is a schematic block diagram of an electronic device according to an exemplary embodiment of the present disclosure.

FIG. 3 is an exemplary diagram for describing a learned identification model used to identify a position of a cantilever according to an exemplary embodiment of the present disclosure.

FIG. 4 is an exemplary diagram for describing a method for calculating a target position using bounding box data according to an exemplary embodiment of the present disclosure.

FIG. 5A to 5D are an exemplary diagram for describing a method for calculating a target position using segmentation data according to an exemplary embodiment of the present disclosure.

FIG. 6 is a flowchart for describing a method for calculating a target position of a cantilever in an atomic microscope system according to an exemplary embodiment of the present disclosure.

### DETAILED DESCRIPTION OF THE EMBODIMENT

Advantages and features of the present disclosure, and methods for accomplishing the same will be more clearly understood from exemplary embodiments to be described below in detail with reference to the accompanying drawings. However, the present disclosure is not limited to the exemplary embodiments set forth below, and will be embodied in various different forms. The exemplary embodiments are just for rendering the disclosure of the present disclosure complete and are set forth to provide a complete understanding of the scope of the invention to a person with ordinary skill in the art to which the present disclosure pertains, and the present disclosure will only be defined by the scope of the claims. In connection with the description of the drawings, like reference numerals may be used for like components.

In the present disclosure, the expression such as “have”, “may have”, “comprise”, “may comprise” or the like indicates the presence of the corresponding feature (e.g., components such as figures, functions, operations, or parts) and does not exclude the presence of an additional feature.

In the present disclosure, the expression such as “A or B”, “at least one of A and/or B”, or “one or more of A and/or B” may include all possible combinations of items listed together. For example, “A or B”, “at least one of A and B”, or “at least one of A or B” may refer to all cases of (1) including at least one A, (2) including at least one B, or (3) including both at least one A and at least one B.

Expressions such as “first,” and “second,” used herein may modify various components regardless of the order and/or importance, and will be used only to distinguish one component from the other component, but are not limit the corresponding components. For example, a first user device and a second user device may represent different user devices, regardless of the order or importance. For example, a first component may be referred to as a second component, and similarly, the second component may also be referred to as the first component without departing from the scope of the present disclosure.

When a certain component (e.g., a first component) is referred to as being “(operatively or communicatively) coupled with/to” or “connected to” to the other component (e.g., a second component), it will be understood that the component may be directly connected to the other component, or may be connected to the other component through another component (e.g., a third component). On the other hand, when a certain component (e.g., a first component) is referred to as being “directly coupled with/to” or “directly connected to” the other component (e.g., a second component), it will be understood that another component (e.g., a third component) is not present between the component and the other component.

The expression of “configured to” used herein may be changed and used to, for example, “suitable for”, “having the capacity to”, “designed to”, “adapted to”, “made to” or “capable of”, depending on the situation. The term “configured to” may not necessarily mean “specially designed to” in hardware. In some situations, the expression “a device configured to” may mean that the device is “capable of” together with other devices or parts. For example, the phrase “a processor configured to perform A, B, and C” may mean a dedicated processor (e.g., an embedded processor) for performing the corresponding operation, or a generic-purpose processor (e.g., a CPU or application processor) capable of performing the corresponding operations by executing one or more software programs stored in a memory device.

The terms used herein are used to illustrate only specific exemplary embodiments, and may not be intended to limit the scope of other exemplary embodiments. A singular form may include a plural form unless otherwise clearly meant in the contexts. The terms used herein, including technical or scientific terms, may have the same meaning as generally understood by those of ordinary skill in the art described in the present disclosure. The terms defined in a general dictionary among the terms used herein may be interpreted in the same or similar meaning as or to the meaning on the context of the related art, and will not be interpreted as an ideal or excessively formal meaning unless otherwise defined in the present disclosure. In some cases, even the terms defined in the present disclosure can not be interpreted to exclude the exemplary embodiments of the present disclosure.

The features of various exemplary embodiments of the present disclosure can be partially or entirely coupled or combined with each other and can be interlocked and operated in technically various ways to be sufficiently appreciated by those skilled in the art, and the exemplary embodiments can be implemented independently of or in association with each other.

Hereinafter, various exemplary embodiments of the present disclosure will be described in detail with reference to the accompanying drawings.

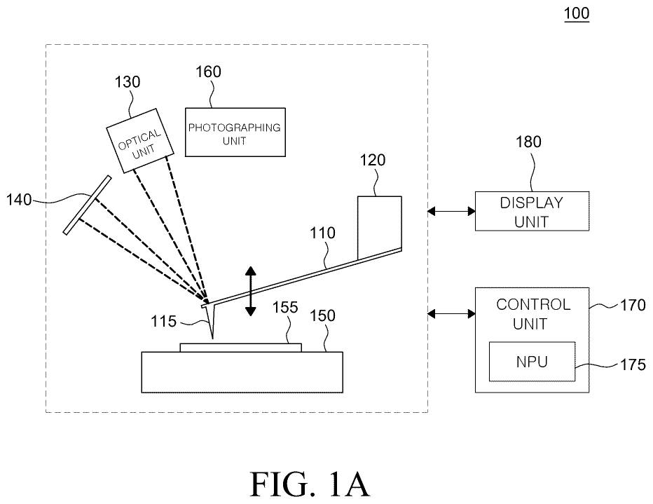

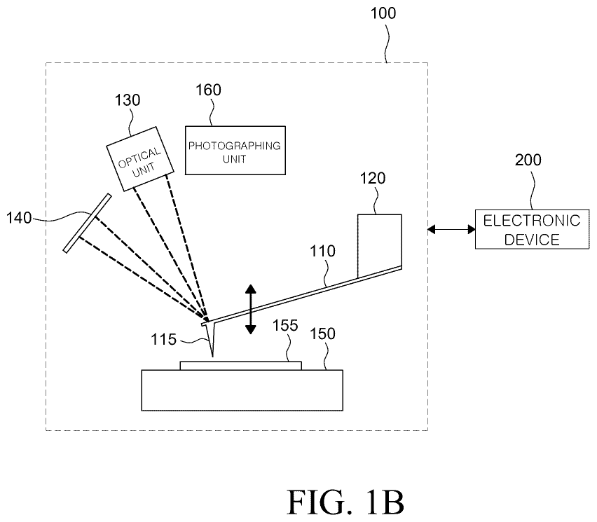

FIGS. 1A and 1B are schematic diagrams for describing an atomic microscope system according to an exemplary embodiment of the present disclosure. In the proposed embodiments, FIG. 1A is a schematic diagram for describing a case where an atomic microscope system is integrated and FIG. 1B is a schematic diagram for describing a case where an atomic microscope system includes an atomic microscope and an electronic device for driving and controlling the atomic microscope.

First, the case where the atomic microscope system is integrated will be described with reference to FIG. 1A.

Referring to FIG. 1A, an atomic microscope system 100 is a microscope apparatus for imaging, analyzing and observing a surface characteristic of a sample in an atomic unit and includes a cantilever 110 having a probe 115 disposed on the lower surface thereof, a first driving unit 120 driving the cantilever 110 to be moved, an optical unit 130 irradiating laser light to a position of the upper surface of the cantilever 110 corresponding to the probe 115, an optical detection unit 140 detecting a position of the laser light reflected from the irradiated position, a second driving unit 150 mounted with a sample 155 and driving to scan the sample 155, a photographing unit 160 for photographing the upper surface of the cantilever 110, a control unit 170 controlling the units, and a display unit 180 displaying a sample image representing the surface characteristic of the sample 155.

The control unit 170 of the atomic microscope system 100 allows the probe 115 disposed on the lower surface of the cantilever 110 to follow and scan the surface of the sample 155 through a Z scanner (not illustrated) or tube scanner (not illustrated) such as a stacked piezo while scanning the sample 155 by the second driving unit 150. While the probe 115 scans the surface of the sample 155, the interaction of atoms between the probe 115 and the surface of the sample 155 may occur, and the attraction pulling the probe 115 toward the surface of the sample 155 and/or the repulsion pushing the probe 115 from the surface of the sample 155 is generated so that the cantilever 110 is bent up and down.

Here, the first driving unit 120 is a driving unit for moving the cantilever 110 so as to be able to change the position of a spot of the laser light to be formed on the surface of the cantilever 110 as described below. The first driving unit 120 is generally provided separately from the Z scanner or tube scanner (not illustrated) described above, but is not excluded to be integrally configured. Further, in addition to the first driving unit 120 and the Z scanner or tube scanner (not illustrated), a Z stage (not illustrated) may be further provided to change a position between the photographing unit 160 and the cantilever 110 to a relatively large displacement.

On the other hand, the first driving unit 120 is illustrated to be directly connected to the cantilever 110 in FIGS. 1A and 1B, but is for convenience of the description and may be connected to the cantilever 110 via other configurations.

The optical unit 130 irradiates the laser light to the target position corresponding to the probe 115 on the upper surface of the cantilever 110, so that the laser light reflected from the cantilever 110 is formed on the optical detection unit 140 such as a position sensitive position detector (PSPD). Accordingly, the bending or twisting of the cantilever 110 may be measured by detecting the motion of the spot of the laser light formed on the optical detection unit 140 and information on the surface of the sample 155 may be acquired. The control unit 170 may display the generated sample image through the display unit 180.

Here, the target position may be a position where the cantilever 110 may be suitably driven to scan the sample. For example, the target position may be a position of the upper surface corresponding to the position of the probe 115 disposed on the lower surface of the cantilever 110 or a predetermined position or a desired position at which the cantilever 110 may be suitably driven for scanning the sample, but is not limited thereto. Since the spot shape or the spot size of the laser light irradiated from the optical unit may be varied depending on a manufacturer of the atomic microscope and a position at which the laser light is irradiated for driving the cantilever may be varied, the aforementioned target position may be various positions based thereon.

As such, in order to acquire the sample image, it is necessary to accurately irradiate the laser light of the optical unit 130 to the target position corresponding to the probe 115, and to this end, it is required to identify the target position corresponding to the probe 115 on the upper surface of the cantilever 110. However, since the cantilever 110 may be variously provided depending on a manufacturer or a measurement purpose, a method for accurately identifying the cantilever is required.

In order to accurately identify the position of the upper surface of the cantilever 110 corresponding to the probe 115, the control unit 170 may photograph the upper surface of the cantilever 110 by the photographing unit 160 and identify the cantilever 110 based on the image photographed by the photographing unit 160.

Here, the photographing unit 160 may be configured to include an objective lens, a barrel, and a CCD camera, and the objective lens and the CCD camera may be connected to the barrel to be configured so that an image optically enlarged by the objective lens may be photographed by the CCD camera. It should be noted that such a specific configuration is a known configuration, which is omitted in FIGS. 1A and 1B.

Specifically, in order to identify the cantilever 110 based on the photographed image, the control unit 170 may use an identification model learned to identify the cantilever 110 based on a plurality of reference images (or learned images) obtained by photographing the cantilever 110 in various environments. Here, the plurality of reference images may be images photographed by changing constantly the illumination intensity around the cantilever 110, and/or a focal distance (that is, a focal distance of the camera and/or the objective lens) of the photographing unit 160, and the like.

The identification model may be an artificial neural network model configured to pre-learn a plurality of reference images and identify the cantilever from a newly input image. In various embodiments, the identification model may be a pre-learned convolutional neural network (CNN), but is not limited thereto. The pre-learned CNN may be configured by one or more layers that perform convolution operations on inputted input values and perform the convolution operations from the input values to deduce output values. For example, the pre-learned CNN may be a Mask R-CNN (regions with convolutional neural network) performing in parallel a classification operation in a plurality of artificial neural network stages, a bounding box regression operation for configuring (or adjusting) a bounding box including a boundary of an object, and a binary masking operation for segmenting an object and a background other than the object, but is not limited thereto.

In the identification model, one stage performs the classification operation and the regression operation to output class label data and bounding box data and the other stage may perform the binary masking operation to output segmentation data.

The control unit 170 may calculate the position corresponding to the probe 115 on the upper surface of the cantilever 110 using the bounding box data and the segmentation data among the data output above.

The control unit 170 may adjust the position of the cantilever 110 and/or the optical unit 130 so as to irradiate the laser light of the optical unit 130 to the calculated position. Here, the position of the cantilever 110 may be adjusted by the first driving unit 120, and a separate driving device may be further provided for the positioning of the optical unit 130.

To process this identification model, the control unit 170 may include a neural processing unit (NPU) 175. The NPU 175 may be an AI chipset (or AI processor) or an AI accelerator. In other words, the NPU 175 may correspond to a processor chip optimized for performing the artificial neural network.

In various exemplary embodiments, an adder, an accumulator, a memory, and the like may be implemented in the NPU 175 in hardware to identify the cantilever 110. Further, the NPU 175 may be implemented as a stand-alone device from the atomic microscope system 100, but is not limited thereto.

Referring to FIG. 1B, the atomic microscope system 100 includes the cantilever 110 disposed with the probe 115, the first driving unit 120, the optical unit 130, the optical detection unit 140, the second driving unit 150 mounted with the sample 155, and the photographing unit 160, and may be separately provided with an electronic device 200 for controlling the units.

The electronic device 200 may include at least one of a tablet personal computer (PC), a notebook, and/or a PC to control the atomic microscope system 100 and identify and adjust the position of the probe 115 of the cantilever 110.

The electronic device 200 may receive an image photographing the upper surface of the cantilever 110 by the photographing unit 160 so that the laser light of the optical unit 130 is irradiated to the position where the probe 115 of the cantilever 110 is disposed and identify the cantilever 110 based on the received image. The above-mentioned identification model may be used to identify the cantilever 110, but is not limited thereto.

The electronic device 200 may calculate a position corresponding to the probe 115 in the identified cantilever 110, and transmit instructions to allow the laser light of the optical unit 130 to be irradiated to the calculated position to the atomic microscope system 100.

Accordingly, the present disclosure uses the artificial neural network model learned to identify the cantilever of the atomic microscope, thereby accurately identifying the target position regardless of the size and shape of the cantilever and automating the beam alignment of the atomic microscope.

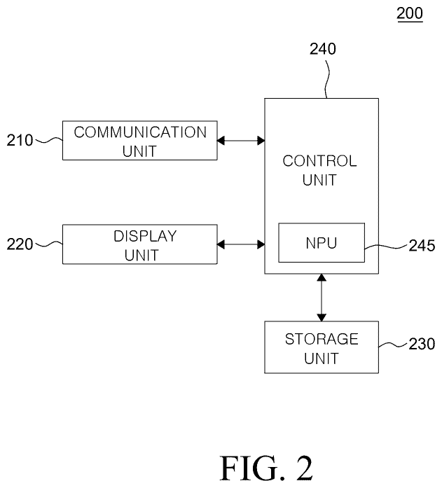

Hereinafter, referring to FIG. 2, the electronic device 200 will be described in more detail.

FIG. 2 is a schematic block diagram of an electronic device according to an exemplary embodiment of the present disclosure.

Referring to FIG. 2, the electronic device 200 includes a communication unit 210, a display unit 220, a storage unit 230, and a control unit 240.

The communication unit 210 connects the electronic device 200 to communicate with an external device. The communication unit 210 may be connected to the atomic microscope system 100 using wired/wireless communication to transmit and receive various data related to the driving and control of the atomic microscope system 100. Specifically, the communication unit 210 may transmit instructions for driving and controlling of the first driving unit 120, the optical unit 130, the optical detection unit 140, the second driving unit 150, and the photographing unit 160 of the atomic microscope system 100, or receive images photographed by the photographing unit 160. In addition, the communication unit 210 may receive a sample image from the atomic microscope system 100.

The display unit 220 may display various contents (e.g., text, image, video, icon, banner or symbol, etc.) to a user. Specifically, the display unit 220 may display the sample image received from the atomic microscope system 100.

In various exemplary embodiments, the display unit 220 may include a touch screen, and may receive, for example, touch using an electronic pen or a part of the body of the user, gesture, approach, drag, swipe or hovering inputs, etc.

The storage unit 230 may store various data used for driving and controlling the atomic microscope system 100. In various exemplary embodiments, the storage unit 230 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The electronic device 200 may operate in connection with a web storage performing a storing function of the storage unit 230 on the Internet.

The control unit 240 is operably connected with the communication unit 210, the display unit 220, and the storage unit 230, and may control the atomic microscope system 100 and perform various commands for identifying the target position of the cantilever 110.

The control unit 240 may be configured to include at least one of a central processing unit (CPU), a graphical processing unit (GPU), an application processor (AP), a digital signal processing unit (DSP), an arithmetic logical operation unit (ALU), and an artificial neural network processor (NPU) 245.

Specifically, the control unit 240 may receive the image photographing the upper surface of the cantilever 110 by the photographing unit 160 of the atomic microscope system 100, by the communication unit 210 and identify the cantilever 110 from the image using the identification model based on the received image. In other words, the control unit 240 may acquire result data on the cantilever 110 identified through the identification model. These result data may include bounding box data and segmentation data as described above.

In various exemplary embodiments, the identification model is stored in an external server, and the control unit 240 may be configured to transmit the image to a server by the communication unit 210 to receive result data calculated from the external server.

The control unit 240 may calculate a target position using at least one of the bounding box data and the segmentation data and transmit instructions for adjusting the driving of the cantilever 110 and/or the optical unit 130 to the atomic microscope system 100 so that the laser light is irradiated to the calculated target position.

As such, the operation of identifying the cantilever 110 using the identification model may be performed by the NPU 245.

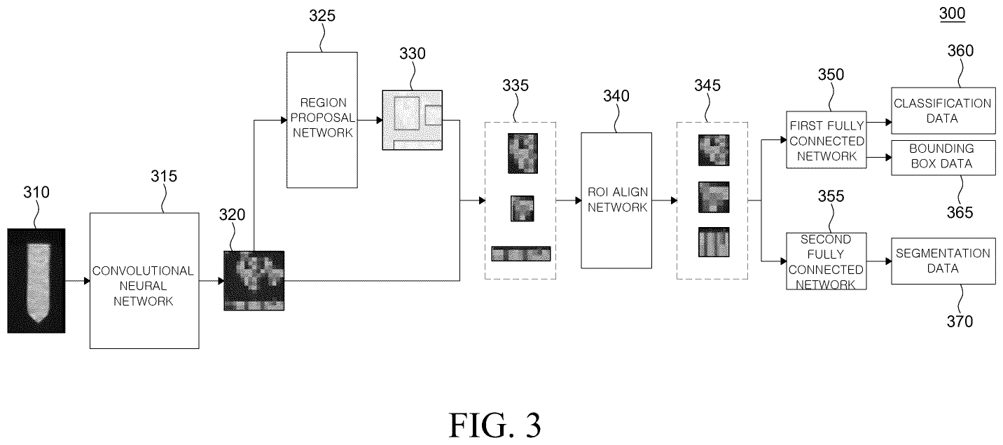

Hereinafter, a method for identifying the cantilever 110 and calculating the position of the probe 115 of the cantilever 110 according to the identification result will be described with reference to FIGS. 3 to 5.

FIG. 3 is an exemplary diagram for describing a learned identification model used to identify a position of a cantilever according to an exemplary embodiment of the present disclosure.

Referring to FIG. 3, a learned identification model 300 may include a plurality of artificial neural network stages.

Specifically, the learned identification model 300 may include a convolutional neural network 315, a region proposal network 325, a region of interest (ROI) align network 340, and a plurality of fully connected networks 350 and 355. Here, the plurality of fully connected networks includes a first fully connected network 350 and a second fully connected network 355.

When an image 310 of the cantilever 110 photographed by the photographing unit 160 is input as an input value of the identification model 300, the identification model 300 may acquire a feature map 320 by the convolutional neural network 315 that performs the convolution operation for extracting a feature from the image.

This feature map 320 is input to the region proposal network 325 for proposing a candidate region to be expected to include the cantilever 110. The identification model 300 may acquire data 330 that includes a region proposal expected to include the cantilever 110 in the feature map 320 and an objectness score thereto by the region proposal network 325.

The identification model 300 may acquire candidate region data 335 based on the feature map 320 outputted by the convolutional neural network 315 and the data 330 outputted by the region proposal network 325. Here, the candidate region data 335 may be data extracted in response to at least one candidate region to be expected to include the cantilever 110 in the feature map 320. At least one candidate region may have various sizes in accordance with a form of a predicted object.

Such candidate region data 335 is input to the ROI align network 340 to be converted to a fixed size using linear interpolation. Here, the fixed size may be in the form of n×n (n>0), but is not limited thereto.

The identification model 300 may output ROI data 345 in an n×n form by the ROI align network 340. At this time, the ROI data 345 may be data obtained by aligning the candidate region data 335 at a fixed size using linear interpolation, but is not limited thereto. This ROI data 345 is input to each of the first fully connected network 350 and the second fully connected network 355. Here, the first fully connected network 350 may include a plurality of fully connected layers, but is not limited thereto. The second fully connected network 355 may be a mask branch network added with an auto encoder structure or at least one fully connected layer (or convolution layer), but is not limited thereto. The auto encoder used herein is an encoder learned to add noise to the input data and then reconfigure and output an original input without noise to improve the segmentation performance of the identification model 300.

The identification model 300 may output classification data 360 and bounding box data 365 through the first fully connected network 350 and output segmentation data 370 through the second fully connected network 355. For example, the bounding box data 365 may be an image representing a bounding box including the cantilever, and the segmentation data 370 may be an image representing the cantilever and a background other than the cantilever.

The bounding box data 365 and the segmentation data 370 outputted as such may be used to calculate the position of the probe 115 of the cantilever 110.

In various exemplary embodiments, post processing for clustering the periphery of the result data may be used to improve the identification accuracy of the identification model. For example, the clustering method may use conditional random field (CRF) and/or Chan-Vese algorithm, etc., but is not limited thereto.

As such, according to the present disclosure, it is possible to improve the identification performance of the atomic microscope by using the learned identification model to increase the operation rate for identifying the position of the probe.

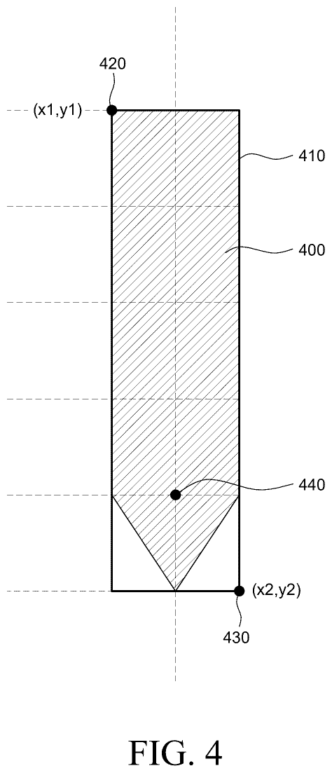

Hereinafter, a method for calculating the target position of the cantilever 110 using the bounding box data will be described in detail with reference to FIG. 4.

FIG. 4 is an exemplary diagram for describing a method for calculating a target position using bounding box data according to an exemplary embodiment of the present disclosure. In the proposed exemplary embodiment, the method may be performed by the control unit 170 of FIG. 1A or the control unit 240 of FIG. 2. Hereinafter, it will be described that the method is performed in the control unit 170 of FIG. 1A.

Referring to FIG. 4, bounding box data includes a rectangular bounding box 410 including a cantilever 400. A coordinate (x1, y1) of a first vertex 420 at the upper left end of the bounding box 410 and a coordinate (x2, y2) of a second vertex 430 at the lower right end thereof may be used to calculate a target position.

Specifically, the control unit 170 may use Equation ‘(x1+x2)/2’ for calculating x and Equation ‘y1+ (y2-y1)× ratio’ for calculating y to calculate a coordinate (x, y) representing a target position 440 (0<ratio<1, default ratio=4/5).

As such, when the coordinate (x, y) is calculated, the control unit 170 may adjust the position of the cantilever 110 and/or the optical unit 130 so as to irradiate the laser light of the optical unit 130 to the calculated coordinate (x, y).

Thus, the present disclosure can automate the beam alignment of the atomic microscope.

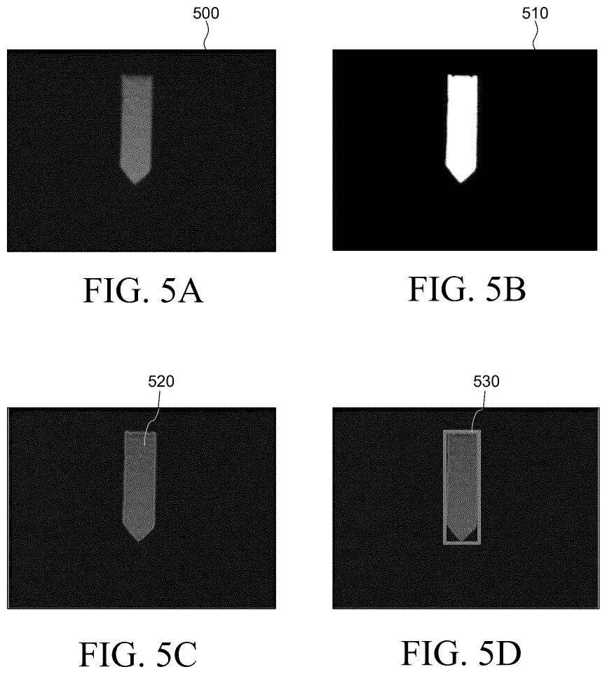

Hereinafter, a method for calculating a target position of the cantilever 110 using segmentation data will be described in detail with reference to FIG. 5.

FIG. 5A to 5D are an exemplary diagram for describing a method for calculating a target position using segmentation data according to an exemplary embodiment of the present disclosure. In the proposed exemplary embodiment, the method may be performed by the control unit 170 of FIG. 1A or the control unit 240 of FIG. 2. Hereinafter, it will be described that the method is performed in the control unit 170 of FIG. 1A.

Referring to FIG. 5A, segmentation data 500 may include a true value representing the cantilever and a false value representing an object except for the cantilever, that is, a background.

The control unit 170 may binarize the segmentation data 500 based on the true value and the false value to generate binary data 510 as illustrated in FIG. 5B.

The control unit 170 may extract an outline 520 from the binary data 510 as illustrated in FIG. 5C. In order to extract the outline, the control unit 170 may use a canny edge detection algorithm and/or a find contour function of OpenCV, but is not limited thereto.

The control unit 170 may generate a bounding box 530 as illustrated in FIG. 5D based on the extracted outline 520. The bounding box 530 may be generated in a rectangular form so that the extracted outline is included.

The control unit 170 may calculate a position of the probe using a coordinate of a first vertex at the upper left end and a coordinate of a second vertex at the upper right end of the generated bounding box 530, and the detailed calculation method may be performed as described in FIG. 4.

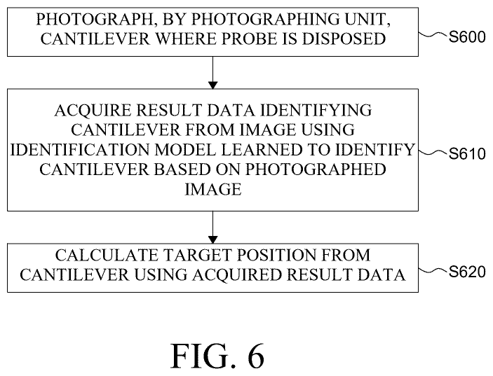

Hereinafter, a method for calculating a target position of a cantilever in an atomic microscope system will be described with reference to FIG. 6.

FIG. 6 is a flowchart for describing a method for calculating a target position of a cantilever in an atomic microscope system according to an exemplary embodiment of the present disclosure. Operations to be described below may be performed by the control unit 170 of FIG. 1A or the control unit 240 of FIG. 2. Hereinafter, it will be described that the method is performed in the control unit 170 of FIG. 1A.

Referring to FIG. 6, the control unit 170 photographs the cantilever 110 disposed with the probe 115 by the photographing unit 160 (S600) and acquires result data identifying the cantilever 110 from an image using the identification model learned to identify the cantilever 110 based on the photographed image (S610). Here, the result data may include bounding box data representing a bounding box including a boundary of the cantilever 110, and segmentation data obtained by segmenting the cantilever 110 and an object other than the cantilever 110 (e.g., background).

The control unit 170 calculates the target position in the cantilever 110 using the acquired result data (S620). Specifically, the control unit 170 may calculate the target position using the bounding box data, or calculate the target position using the segmentation data.

In the case of using the bounding box data, the control unit 170 may calculate the target position using coordinate values for a plurality of vertices that form the bounding box.

In the case of using the segmentation data, the control unit 170 may acquire binary data by binarizing the segmentation data and detect the outline of the cantilever 110 using the acquired binary data. The control unit 170 may generate a bounding box including the detected outline, and calculate a target position using the coordinate values for a plurality of vertices that form the generated bounding box.

As such, when the target position is calculated, the control unit 170 may adjust the position of the cantilever 110 by the first driving unit 120 so that the laser light of the optical unit 130 is irradiated to the target position. Also, the position of the optical unit 130 may be adjusted by a separate driving device.

Accordingly, according to the present disclosure, it is possible to accurately identify a target position suitable for scanning the sample by the cantilever regardless of the size and shape of the cantilever by using an artificial neural network model learned to identify the cantilever of the atomic microscope.

The apparatus and the method according to the exemplary embodiments of the present disclosure are implemented in a form of program instructions which may be performed by various computer means and may be recorded in a computer readable recording medium. The computer readable medium may include program instructions, data files, data structures, and the like alone or in combination.

The program instructions recorded in the computer readable medium may be specially designed and configured for the present disclosure, or may be publicly known and used by those skilled in a computer software field. Examples of the computer readable medium include magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program instruction. Examples of the program instructions include high language codes executable by a computer using an interpreter and the like, as well as machine language codes created by a compiler.

The hardware device described above may be configured to be operated as one or more software modules to perform the operation of the present disclosure and vice versa.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments disclosed in the present disclosure are intended not to limit the technical spirit of the present disclosure but to describe the present disclosure and the scope of the technical spirit of the present disclosure is not limited by these exemplary embodiments. Therefore, it should be understood that the above-described exemplary embodiments are illustrative in all aspects and do not limit the present disclosure. The protective scope of the present disclosure should be construed based on the appended claims, and all the technical spirits in the equivalent scope thereof should be construed as falling within the scope of the present disclosure.

What is claimed is:

1. An apparatus for identifying a target position of an atomic microscope, the apparatus comprising:
a cantilever configured to dispose a probe for scanning a sample;
a first driving unit that is directly connected to the cantilever and is configured to drive the cantilever to be moved relative to the sample;
a photographing unit configured to output an image of the cantilever by photographing an upper surface of the cantilever; and
a control unit operably connected with the cantilever and the photographing unit,
wherein the control unit is configured to
obtain a plurality of reference images by operating the photographing unit before acquiring the result data, the plurality of reference images obtained according to an ambient environment of the cantilever by photographing a plurality of cantilevers of different cantilever manufacturers,
acquire result data identifying the cantilever, the result data acquired by training an artificial neural network as an identification model using machine learning to identify the cantilever based on the image outputted from the photographing unit and the plurality of reference images,
calculate the target position using the result data, and
control the first driving unit to adjust a position of the cantilever so that laser light from an optical unit is irradiated to the calculated target position,
wherein the result data include bounding box data representing a rectangular bounding box forming a boundary of the cantilever and segmentation data obtained by segmenting the cantilever and a background other than the cantilever,
wherein the photographing unit is further configured to obtain the plurality of reference images while changing an illumination intensity around each of the plurality of cantilevers, the plurality of reference images including a first series of reference images for each of the plurality of cantilevers, each of the first series of reference images obtained using a different illumination intensity,
wherein the photographing unit is further configured to obtain the plurality of reference images while changing a focal distance of the photographing unit with respect to each of the plurality of cantilevers, the plurality of reference images further including a second series of reference images for each of the plurality of cantilevers, each of the second series of reference images obtained using a different focal distance,
wherein the control unit is further configured to perform post processing on the result data after acquiring the result data, the post processing including
a first-image clustering process performed with respect to a first image, the first-image clustering process including inputting post-processing results of the first image to the artificial neural network, the first image including an image of a periphery of an image representing the rectangular bounding box containing the cantilever, and
a second-image clustering process performed with respect to a second image, the second-image clustering process including inputting post-processing results of the second image to the artificial neural network, the second image including an image of a periphery of an image representing the cantilever and the background other than the cantilever,
wherein the identification model includes a first fully connected network and a second fully connected network connected in parallel to the first fully connected network,
wherein the post processing is performed using the bounding box data as the first image and employs at least one of a conditional random field (CRF) model and a Chan-Vese segmentation algorithm with respect to the bounding box data from the first fully connected network, and
wherein the post processing is performed using the segmentation data as the second image and employs at least one of the CRF model and the Chan-Vese segmentation algorithm with respect to the segmentation data from the second fully connected network.

2. The apparatus of claim 1,
wherein the optical unit is configured to irradiate the laser light to a position on an upper surface of the cantilever corresponding to a position of the probe on a lower surface of the cantilever, and
wherein the control unit is further configured to control a second driving unit mounted with the sample, the second driving unit including a Z scanner controlled such that the probe scans a surface of the sample, the scanning by the probe generating attraction and repulsion forces whereby the probe is pulled toward the surface of the sample by the cantilever being bent downward and whereby the probe is pushed from the surface of the sample by the cantilever being bent upward.

3. The apparatus of claim 1, further comprising:
an optical unit configured to irradiate laser light to the upper surface of the cantilever,
wherein the control unit is further configured to adjust a position of the optical unit so that the laser light of the optical unit is irradiated to the calculated target position.

4. The apparatus of claim 1, wherein the control unit is further configured to calculate coordinate values (x, y) of the target position using a first vertex (x1, y1) at an upper left corner of the rectangular bounding box and a second vertex (x2, y2) at a lower right corner of the rectangular bounding box, according to
x=(x1+x2)/2 and
y=y1+ (y2−y1)× ratio, where 0<ratio<1,
wherein the ratio has a default value of 4/5.

5. The apparatus of claim 4, wherein the control unit is further configured to
acquire binary data by binarizing the segmentation data,
detect an outline of the cantilever using the acquired binary data, and
generate the rectangular bounding box including the detected outline, wherein the segmentation data includes true values representing the cantilever and false values representing the background object,
wherein the segmentation data is binarized based on the true values and the false values, to generate the binary data,
wherein the outline of the cantilever is extracted from the binary data.

6. The apparatus of claim 1,
wherein the artificial neural network model includes a Mask R-CNN configured to perform, in parallel, each of
a classification operation in a plurality of artificial neural network stages,
a bounding box regression operation for adjusting the rectangular bounding box, and
a binary masking operation for segmenting the cantilever and the background object;
wherein the classification operation and the regression operation are performed in one stage of the plurality of artificial neural network stages, to output class label data and the bounding box data; and
wherein the binary masking operation is performed in another stage of the plurality of artificial neural network stages, to output the segmentation data.

7. The apparatus of claim 1,
wherein the identification model further includes a series connection of a convolutional neural network, a region proposal network, and a region of interest (ROI) align network, the ROI align network disposed between the region proposal network and the first and second fully connected networks;
wherein the convolutional neural network is configured to output a feature map by performing a convolution operation for extracting a feature from the image captured by the photographing unit;
wherein the region proposal network is configured to output candidate region data for each of a plurality of candidate regions expected to include the cantilever by taking feature map extracted based on the captured image as an input, the candidate region data acquired by combining the feature map and data that includes at least one region proposal and an objectness score for a region corresponding to the at least one region proposal;
wherein the ROI align network is configured to take the candidate region data as an input and output ROI data aligned with data having a preset size;
wherein the first fully connected network is configured to output the bounding box data by taking the ROI data as an input; and
wherein the second fully connected network is configured to output the segmentation data by taking the ROI data as an input.

8. A method for identifying a target position of an atomic microscope, the method comprising:
photographing, using a photographing unit, an upper surface of a cantilever configured to dispose a probe for scanning a sample;
obtaining a plurality of reference images by operating the photographing unit before acquiring the result data, the plurality of reference images obtained according to an ambient environment of the cantilever by photographing a plurality of cantilevers of different cantilever manufacturers;
acquiring result data identifying the cantilever, the result data acquired by training an artificial neural network as an identification model using machine learning to identify the cantilever based on an image from the photographing unit and the plurality of reference images;
calculating the target position using the result data; and
adjusting a position of the cantilever by controlling a first driving unit so that laser light from an optical unit is irradiated to the calculated target position, the first driving unit being directly connected to the cantilever and configured to drive the cantilever to be moved relative to the sample,
wherein the result data include bounding box data representing a rectangular bounding box forming a boundary of the cantilever and segmentation data obtained by segmenting the cantilever and a background other than the cantilever,
wherein the plurality of reference images are obtained while
changing an illumination intensity around each of the plurality of cantilevers, the plurality of reference images including a first series of reference images for each of the plurality of cantilevers, each of the first series of reference images obtained using a different illumination intensity, and
changing a focal distance of the photographing unit with respect to each of the plurality of cantilevers, the plurality of reference images further including a second series of reference images for each of the plurality of cantilevers, each of the second series of reference images obtained using a different focal distance,
wherein the method further comprises performing post processing on the result data after acquiring the result data, the post processing including
a first-image clustering process performed with respect to a first image, the first-image clustering process including inputting post-processing results of the first image to the artificial neural network, the first image including an image of a periphery of an image representing the rectangular bounding box containing the cantilever, and
a second-image clustering process performed with respect to a second image, the second-image clustering process including inputting post-processing results of the second image to the artificial neural network, the second image including an image of a periphery of an image representing the cantilever and the background other than the cantilever,
wherein the identification model includes a first fully connected network and a second fully connected network connected in parallel to the first fully connected network,
wherein the post processing is performed using the bounding box data as the first image and employs at least one of a conditional random field (CRF) model and a Chan-Vese segmentation algorithm with respect to the bounding box data from the first fully connected network, and
wherein the post processing is performed using the segmentation data as the second image and employs at least one of the CRF model and the Chan-Vese segmentation algorithm with respect to the segmentation data from the second fully connected network.

9. The method of claim 8, wherein the optical unit is configured to irradiate the laser light to a position on an upper surface of the cantilever corresponding to a position of the probe on a lower surface of the cantilever,
the method further comprising controlling a second driving unit mounted with the sample, the second driving unit including a Z scanner controlled such that the probe scans a surface of the sample, the scanning by the probe generating attraction and repulsion forces whereby the probe is pulled toward the surface of the sample by the cantilever being bent downward and whereby the probe is pushed from the surface of the sample by the cantilever being bent upward.

10. The method of claim 8, wherein the calculating the target position includes calculating coordinate values (x, y) of the target position using a first vertex (x1, y1) at an upper left corner of the rectangular bounding box and a second vertex (x2, y2) at a lower right corner of the rectangular bounding box, according to
x=(x1+x2)/2 and
y=y1+ (y2−y1)× ratio, where 0<ratio<1,
wherein the ratio has a default value of 4/5.

11. The method of claim 10, wherein the calculating the target position further includes:
acquiring binary data by binarizing the segmentation data,
detecting an outline of the cantilever using the acquired binary data, and
generating the rectangular bounding box including the detected outline.
